(19) United States
(12) Patent Application Publication
(10) Pub. No.: US 2009/0164596 A1
(43) Pub. Date: Jun. 25, 2009

(54) IMAGE PROCESSING APPARATUS AND DATA ENCRYPTION COMMUNICATION SYSTEM

(75) Inventor: Masahiro Sakiyama, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/335,823

(22) Filed: Dec. 16, 2008

(30) Foreign Application Priority Data
Dec. 19, 2007 (JP) 2007-327524

(51) Int. Cl. G06F 15/16

(52) U.S. Cl. 709/206

(57) ABSTRACT

An image processing apparatus according to an embodiment of the present invention transmits to a mail server a notification email inquiring to a client apparatus of an address whether encrypted data is to be received, and if a reply email is received from the mail server in response to the notification email, wherein the reply email is sent from the client apparatus of the address and indicates to receive the encrypted data, and a password is assigned to the received reply email, the image processing apparatus encrypts data using the password, attaches the encrypted data to an email to be sent to the address, and transmits the email to the mail server.

This application claims priority under 35 U.S.C. §119(a) on Patent Application No. 2007-327524 filed in Japan on Dec. 19, 2007, the entire contents of which are herein incorporated by reference.

### BACKGROUND OF THE INVENTION

1. Field of the Invention

The present invention relates to an image processing apparatus that executes a network scanner function of transmitting an image read by a scanner by email attachment, and a data encryption communication system, and more particularly to an encryption technique for when transmitting data to a plurality of addresses.

2. Related Art

In the latest office environments, email data is transmitted to a large number of addresses using a function for transmitting data read by an image reading unit of an image processing apparatus by email attachment. The data can, at this time, be transmitted after being converted to encrypted data that can only be viewed by designating a password.

JP H11-122294 (hereinafter, Patent Document 1), for example, discloses a recipient acquiring confidential email information using a password operation.

However, with Patent Document 1, the password used for encryption is common to all addresses, and therefore needs to be shared with all users constituting the addresses. Thus, data transmission to a plurality of users that do not want to share a password cannot be performed with a single execution. That is, data transmission needs to be performed after repeatedly setting a different password for each address, costing time and effort.

With the above patent document 1, an email cannot be received with a password designated by a user. Users, thus having to remember a password set by someone else, would have had difficulty recalling the password if they forgot it, in which case they would not be able to decode the acquired data.

Also, when thus transmitting data to a plurality of addresses with a single transmission, checking whether data had been reliably transmitted to the individual addresses takes effort. Further, if there remains unsent data, the question of what to do with this data (i.e., whether to delete unsent data or whether to transmit it despite there not being transmission request from the address) is also problematic.

### SUMMARY OF THE INVENTION

The present invention was made in view of such circumstances, and has as its object to provide an image processing apparatus and a data encryption communication system that simplify the process of encryption on the transmitting side and the receiving side, and facilitate management of data transmission to a plurality of addresses, by enabling a user who has received an email to designate a password for use in encryption by replying to the email, when transmitting encrypted data to a plurality of addresses with a network scanner function of transmitting data read by a scanner by email attachment.

An image processing apparatus of the present invention is connected to a mail server via a network and has an email function of transmitting to the mail server an email addressed to an address designated as a destination and receiving from the mail server an email addressed to the image processing apparatus, and an image transmission function of encrypting data read from an original set on an original table and transmitting to the mail server the encrypted data as email attachment data. The image processing apparatus includes a notification email transmission means for transmitting to the mail server a notification email inquiring to a client apparatus of an address whether the encrypted data is to be received, a reply email reception means for receiving a reply email from the mail server in response to the notification email, wherein the reply email is sent from the client apparatus of the address and indicates to receive the encrypted data, and a data transmission means for encrypting the data using a password assigned to the received reply email, attaching the encrypted data to an email to be sent to the address as attachment data, and transmitting the email to the mail server. In this case, when a plurality of addresses are designated as destinations, the data transmission means may individually attach encrypted data to emails to be sent to these addresses and transmit the emails thereto, with each the data being encrypted using a password designated in a reply email received from a client apparatus of each of the addresses.

That is, since the sender does not need to set passwords individually for the different addresses before transmitting data, unlike the prior art, encryption can be performed individually for the different addresses, while avoiding the sharing of passwords on the address side. On the other hand, because the recipient at an address who receives data from the image processing apparatus is able to decode the data using a password designated by him or herself, encrypted data can be reliably decoded. In this case, even if the recipient forgets the password, the password will be comparatively easy to recall given that it was designated by the recipient him or herself, thus making for ease of use.

The image processing apparatus of the present invention may be configured so as to further include a validity period setting means for setting a validity period for which to continue to hold the data even after data transmission to all addresses is complete, and a job management means for managing, as a job, the data, a sender, one or more addresses, a validity period condition and information on a notification email, and such that the job management means associates a received reply email with a job currently being managed. Thus, by providing a validity period, a user at an address can receive the data again if within the validity period, even after the data has been transmitted to all of the addresses.

The image processing apparatus of the present invention may be configured such that if a job associated with a reply email received from a client apparatus of an address does not exist, the image processing apparatus transmits an email notifying the client apparatus of the address that the validity period has expired and the job has been deleted. A user at addresses can thereby be notified that a job does not exist.

The image processing apparatus of the present invention may be configured so as to further include a means for setting whether to, after the validity period has expired, automatically transmit data or cancel data transmission, with respect to an address to which the held data has not been transmitted. Whether or not to transmit data to addresses from which a reply is not received within the validity period can thereby be selected at the sender's end.

The image processing apparatus of the present invention may be configured such that if cancellation of data transmission after the validity period has expired is set with respect to an address to which the held data has not been transmitted, the image processing apparatus notifies a client apparatus of the address by email when the validity period expires that data transmission has been canceled due to the validity period having expired. The fact that the validity period has expired can thereby be notified to addresses from which a reply is not received within the validity period.

The image processing apparatus of the present invention may be configured such that if cancellation of data transmission after the validity period has expired is set with respect to an address to which the held data has not been transmitted, the image processing apparatus notifies, to a client apparatus of the sender when the validity period has expired, a list of addresses with respect to which data transmission has been cancelled. The sender is thereby able to be aware of addresses to which data was not transmitted due to the validity period having expired.

The image processing apparatus of the present invention may be configured such that if a reply email indicating not to receive the encrypted data is received from a client apparatus of an address during the set validity period, the image processing apparatus cancels data transmission to the address. A user at an address is thereby able to cancel data reception if there is no need to receive notified data.

The image processing apparatus of the present invention may be configured to notify, by email to a client apparatus of the sender, information indicating the address to which data transmission was canceled. The sender is thereby able to be aware of addresses that have cancelled data reception.

The image processing apparatus of the present invention may be configured, when executing the image transmission function, to set automatically on its own a character string for use as a password in a case where a character string serving as a password is not designated by a client apparatus of an address (alternatively, a password preset as a default may be used). Data can thereby be transmitted, even with respect to a reply email that does not designate a password.

The image processing apparatus of the present invention may be configured such that in a case where a character string serving as a password is not designated in a reply email received from a client apparatus of an address, the image processing apparatus sets whether to invalidate the reply email and inhibit data transmission to the address or encrypt the data using the password set for use when a password is not designated, attach the encrypted data to an email to be sent to the address and transmit the email.

The image processing apparatus of the present invention may be configured such that in a case where a character string serving as a password is not designated in a reply email received from a client apparatus of an address, and invalidating the reply email and inhibiting data transmission to the address has been set, the image processing apparatus transmits to the client apparatus of the address an email notifying that the reply email is invalid. A user at an address is thereby able to know that data was not transmitted due to the reply email sent by the user being invalid.

The image processing apparatus of the present invention may be configured such that if invalid description is included in a reply email received from a client apparatus of an address, the image processing apparatus recognizes only valid description included in the reply email as an instruction. It is thereby possible to reliably recognize only the valid description in a reply email, even if a reply email is received in which unrelated description such as citation of a notification email remains.

The image processing apparatus of the present invention may be configured, when executing the image transmission function, to transmit to the client apparatus of the sender an email, wherein a content of the email is to inquire whether the encrypted data is to be received and additionally includes a statement that the email was sent by a receiver of the email himself. Because a notification email can be sent to the client apparatus of the sender even if the sender has not been added to the addresses, the sender is thereby able to receive, as a notification email, emails transmitted by him or herself to the addresses.

The image processing apparatus of the present invention may be configured such that when a reply email to the email transmitted to the client apparatus of the sender is received, the job management means saves, in association with the job currently being managed, information indicating that the received reply email was in reply to an email transmitted to the sender. The job management means is thereby able to distinguish a reply email from the sender from a reply email from an address.

A data encryption communication system of the present invention is configured such that an image processing apparatus as described above of the present invention, a mail server, a client apparatus of an address that receives an email transmitted from the image processing apparatus and transmits a reply email to the received email, and a client apparatus of a sender are connected to one another via a network.

### BRIEF DESCRIPTION OF THE DRAWINGS

FIG. 1 shows the overall configuration of a data encryption communication system that includes an image processing apparatus according to an embodiment of the present invention.

FIG. 2 is a block diagram showing a more detailed configuration of the apparatuses and the mail server shown in FIG. 1.

FIG. 3 is a flowchart for illustrating a data encryption communication processing operation in the data encryption communication system that includes the image processing apparatus according to an embodiment of the present invention.

FIG. 4 is a flowchart for illustrating a reply email analysis processing operation in the data encryption communication system that includes the image processing apparatus according to an embodiment of the present invention.

FIG. 5 is a flowchart showing an address response process implemented at step S410 of FIG. 4.

FIG. 6 is a flowchart showing a sender response process implemented at step S411 of FIG. 4.

FIG. 7 shows exemplary description of an email notified to a user at an address, in the data encryption communication system that includes the image processing apparatus according to an embodiment of the present invention.

FIG. 8 shows exemplary description of an email notified to a sender, in the data encryption communication system that includes the image processing apparatus according to an embodiment of the present invention.

FIG. 9 shows exemplary description of an email notifying a user at an address to which data is unsent that a validity period has expired, in the data encryption communication system that includes the image processing apparatus according to an embodiment of the present invention.

FIG. 10 shows exemplary description of an email listing addresses to which data is unsent that responded to the sender after the validity period had expired, in the data encryption communication system that includes the image processing apparatus according to an embodiment of the present invention.

FIG. 11 shows exemplary description of an email sent in response to a reply email transmitted after the validity period has expired, in the data encryption communication system that includes the image processing apparatus according to an embodiment of the present invention.

FIG. 12 shows exemplary description of a reply email in which a user at an address has instructed to cancel data reception, in the data encryption communication system that includes the image processing apparatus according to an embodiment of the present invention.

FIG. 13 shows exemplary description of an email notifying the sender that a user at an address has cancelled data reception, in the data encryption communication system that includes the image processing apparatus according to an embodiment of the present invention.

FIG. 14 shows exemplary description of a response email to a reply email that does not designate a password, in the case where invalidating reply emails that do not designate a password has been set, in the data encryption communication system that includes the image processing apparatus according to an embodiment of the present invention.

FIG. 15 shows exemplary description of a reply email in which a user at an address has instructed a password for receiving data, in the data encryption communication system that includes the image processing apparatus according to an embodiment of the present invention.

FIG. 16 shows exemplary description of an email notifying the sender that an instruction for receiving data has been given by a user at an address who has already instructed cancellation, in the data encryption communication system that includes the image processing apparatus according to an embodiment of the present invention.

FIG. 17 shows exemplary description of a reply email in which the sender instructs to cancel a job, in the data encryption communication system that includes the image processing apparatus according to an embodiment of the present invention.

FIG. 18 shows exemplary description of an email notifying a user at an address to which data is unsent that the sender has cancelled the job, in the data encryption communication system that includes the image processing apparatus according to an embodiment of the present invention.

FIG. 19 shows exemplary description of a reply email in which the sender instructs a password for receiving data, in the data encryption communication system that includes the image processing apparatus according to an embodiment of the present invention.

FIG. 20 shows exemplary description of a reply email in which the sender instructs a validity period change, in the data encryption communication system that includes the image processing apparatus according to an embodiment of the present invention.

FIG. 21 shows exemplary description of an email notifying a user at an address to which data is unsent that the sender has changed the validity period of the job, in the data encryption communication system that includes the image processing apparatus according to an embodiment of the present invention.

FIG. 22 shows exemplary description of a reply email in which the sender instructs acquisition of a list of addresses to which data is unsent, in the data encryption communication system that includes the image processing apparatus according to an embodiment of the present invention.

FIG. 23 shows exemplary description of a response email to a reply email instructing acquisition of a list of addresses to which data is unsent, in the data encryption communication system that includes the image processing apparatus according to an embodiment of the present invention.

### DESCRIPTION OF THE PREFERRED EMBODIMENTS

Hereinafter, an embodiment of the present invention will be described with reference to the drawings.

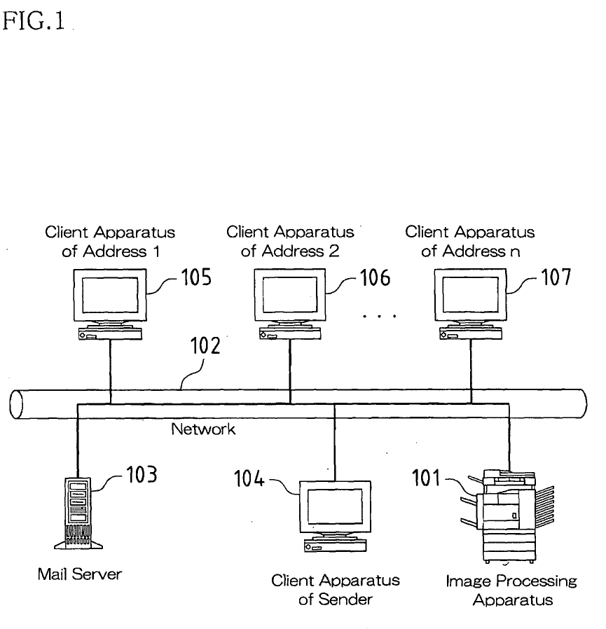

FIG. 1 shows the overall configuration of a data encryption communication system that includes an image processing apparatus according to an embodiment of the present invention.

This data encryption communication system is constituted such that an image processing apparatus 101 that executes a network scanner function of transmitting data (various types of image data such as photos, pictures, graphics, text) read by a scanner by email attachment, a mail server 103, one or a plurality of client apparatuses 105, 106, . . . , n of addresses that receive an email transmitted from the image processing apparatus 101 and transmit a reply email to the received email, and a client apparatus 104 of a sender are communicably connected to one another via a prescribed network 102 such as the Internet, a LAN or a WAN. That is, the image processing apparatus 101 is connected to the mail server 103, the client apparatus 104 of the sender, and n number of the client apparatuses 105, 106, . . . , n of the addresses through the network 102, and can transmit and receive emails with the client apparatuses 104, 105, 106, . . . , n via the mail server 103.

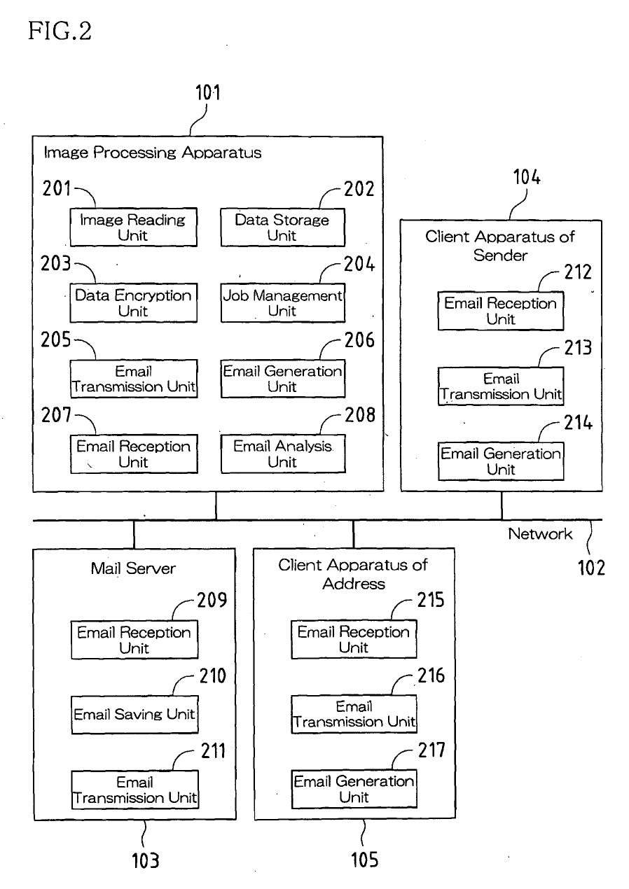

FIG. 2 shows a more detailed configuration of the apparatuses and the mail server shown in FIG. 1.

The image processing apparatus 101, which is composed of an image reading unit 201, a data storage unit 202, a data encryption unit 203, a job management unit 204, an email transmission unit 205, an email generation unit 206, an email reception unit 207 and an email analysis unit 208, respectively manages data read by the image reading unit 201 in the data storage unit 202 and job information in the job management unit 204. A notification email to an address and an email to which data is attached are created by the email generation unit 206, and transmitted via the email transmission unit 205 to the mail server 103 over the network. Data for attaching to an email is converted to encrypted data by the data encryption unit 203. A reply email from an address or the sender is received by the email reception unit 207, and the content is analyzed by the email analysis unit 208.

The mail server 103, which is composed of an email reception unit 209, an email saving unit 210 and an email transmission unit 211, receives emails transmitted by the image processing apparatus 101 and the client apparatuses 104, 105, 106, . . . , n with the email reception unit 209, and saves received emails in the email saving unit 210. If there is a transmission request from the image processing apparatus 101 or the client apparatuses 104, 105, 106, . . . , n, the mail server 103 transmits, with the email transmission unit 211, an email to the image processing apparatus 101 or the client apparatuses 104, 105, 106, . . . , n from which the transmission request originated.

The client apparatus 104 of the sender, which is composed of an email reception unit 212, an email transmission unit 213 and an email generation unit 214, receives an email from the mail server 103 with the email reception unit 212, generates a reply email with the email generation unit 214, and transmits the reply email to the mail server 103 from the email transmission unit 213.

The client apparatuses 105, 106, . . . , n, of the addresses, which are each composed of an email reception unit 215, an email transmission unit 216 and an email generation unit 217, receive an email from the mail server 103 with the email reception unit 215, generate a reply email with the email generation unit 217, and transmit the reply email to the mail server 103 from the email transmission unit 216.

Hereinbefore were the basic processing operations of the apparatuses and the mail server.

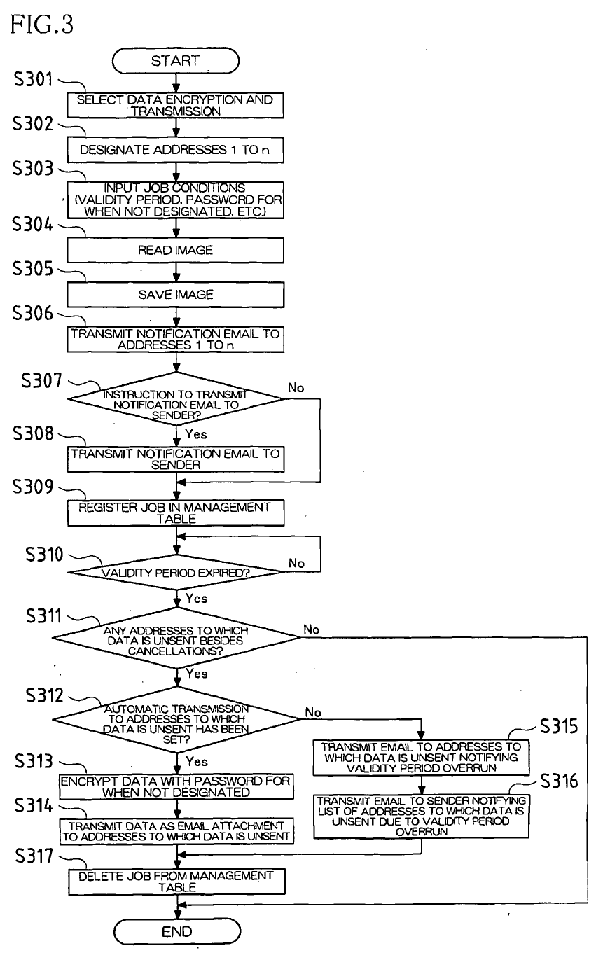

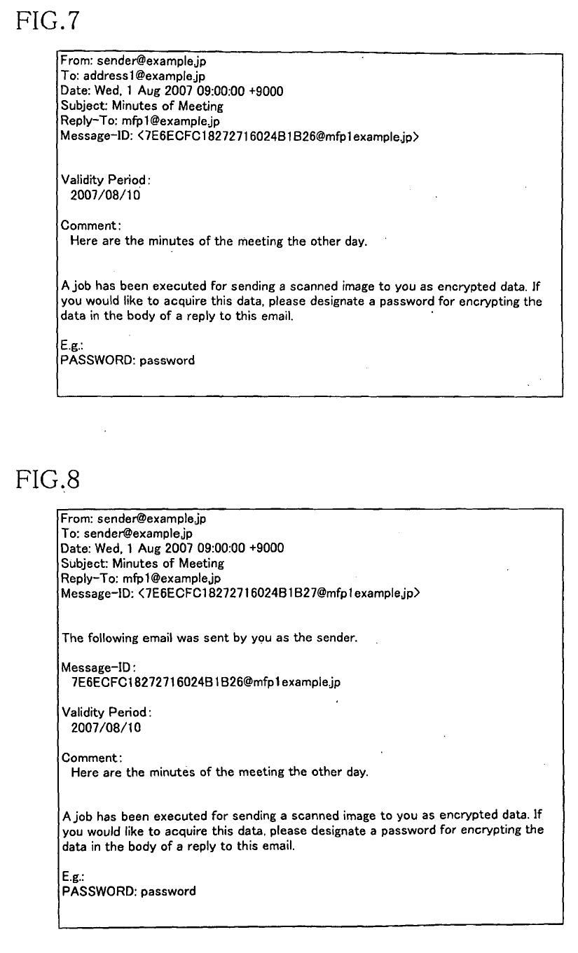

Next, primarily the processing operations of data encryption communication by the image processing apparatus 101 in a data encryption communication system having the above configuration will be sequentially described with reference to the flowcharts shown in FIGS. 3 to 6 and the exemplary email descriptions shown in FIGS. 7 to 23.

Firstly, a function of encrypting and transmitting data is selected with the image processing apparatus 101 (step S301), and, next, an address to which data is to be transmitted is selected (step S302). Then, processing is performed to set a validity period, designate an operation for when the validity period expires, designate an operation for when a password has not been designated, set a password to be used when a password has not been designated, and set whether to also transmit a notification email to the sender, as conditions of the job to be executed (step S303).

Once the job conditions are thus set, an image is read by the image reading unit 201 (step S304), and after saving the read data in the data storage unit 202 (step S305), a notification email is created with the email generation unit 206 for notifying each address that encrypted data is to be transmitted using the image transmission function, and the created notification email is transmitted to the mail server 103 from the email transmission unit 205 (step S306).

FIG. 7 shows exemplary content of a notification email transmitted to an address at this time. With this notification email, the comment, “A job has been executed for sending a scanned image to you as encrypted data. If you would like to acquire this data, please designate a password for encrypting the data in the body of a reply to this email,” is displayed in the comment field in particular, prompting the user at the address to input a password for use in encryption.

Next, the image processing apparatus 101 judges whether transmission of a notification email to the sender is set (step S307), and if set, the image processing apparatus 101 creates a notification email to the sender with the email generation unit 206, and transmits the created notification email to the mail server 103 from the email transmission unit 205 (step S308).

FIG. 8 shows exemplary content of a notification email transmitted to the sender at this time. The content of this notification email is basically almost the same as the content of the email to the address shown in FIG. 7, although with the notification email in FIG. 8, a confirmation message indicating that this email was sent by the sender (a receiver of this email himself) has been added.

Once a notification email is thus transmitted, the image processing apparatus 101 registers the data, information for determining the job from a reply email, the sender, the address(es) and the job conditions in a job management table of the job management unit 204 (step S309).

Once the data encryption communication preprocessing is thus complete, the image processing apparatus 101 next periodically determines whether the validity period has expired (step S310), and if the validity period has expired, the image processing apparatus 101 determines, as validity period overrun processing, whether there are any addresses to which data is unsent besides those addresses that have instructed cancellation (step S311).

If there are no addresses to which data is unsent (if No at step S311), the job is deleted from the job management table (step S317), and processing of the job is ended.

On the other hand, if there are addresses to which data is unsent besides those that have instructed cancellation (if Yes at step S311), the image processing apparatus 101 judges whether automatic transmission of saved data to addresses to which data is unsent after the validity period expires is set (step S312).

If automatic transmission to addresses to which data is unsent has been set (if Yes at step S312), the image processing apparatus 101 encrypts the data using the password initially set for use when a password is not designated, since a password has not been designated by these addresses at this point (step S313), and after transmitting the encrypted data to the addresses to which data is unsent as an email attachment (step S314), the job is deleted from the job management table (step S317), and processing of the job is ended.

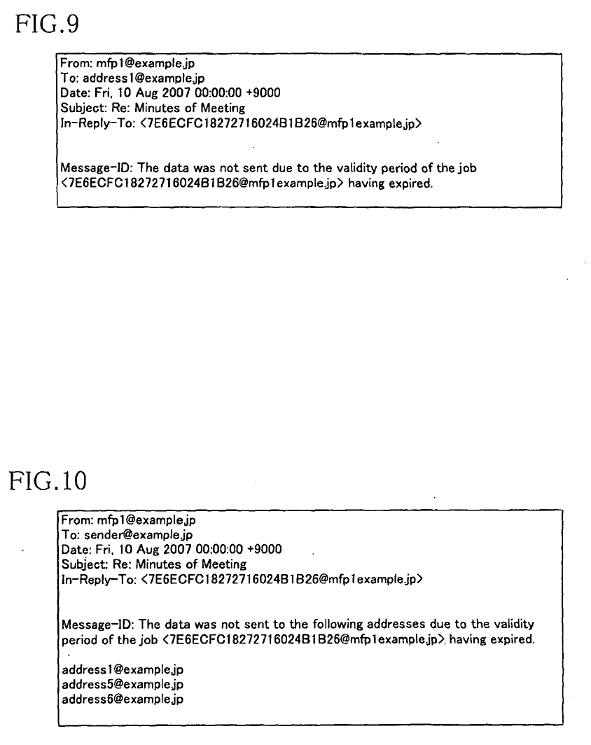

On the other hand, if there are addresses to which data is unsent besides those that have instructed cancellation, and automatic transmission to addresses to which data is unsent after the validity period has expired is not set (if Yes at step S311 and No at step S312), the image processing apparatus 101 transmits an email (see FIG. 9) to the addresses to which data is unsent notifying that the validity period has expired (step S315), and after transmitting an email (see FIG. 10) to the sender listing any addresses to which data is unsent due to the validity period having expired (step S316), the job is deleted from the job management table (step S317), and processing of the job is ended.

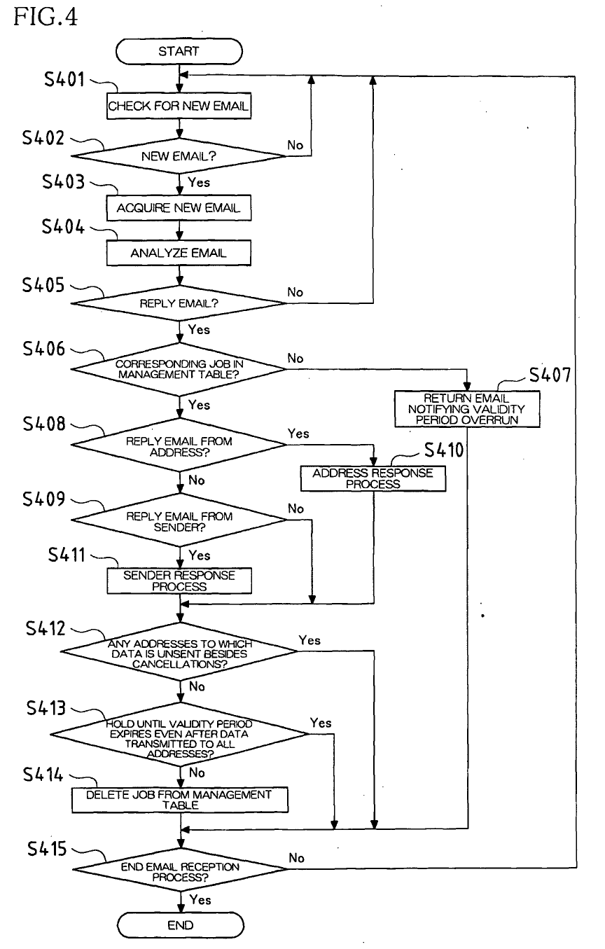

Next, a reply email analysis process performed by the image processing apparatus 101 when a reply email is received from the client apparatuses 105, 106, . . . , n of the addresses or the client apparatus 104 of the sender via the mail server 103 will be described with reference to the flowchart shown in FIG. 4.

With the reply email analysis process, the image processing apparatus 101 periodically checks the mail server 103 (step S401), and determines whether there is a new email (step S402). If there is a new email, the image processing apparatus 101 then acquires this new email (step S403), and analyzes the content with the email analysis unit 208 and removes only valid description (step S404).

Having analyzed the new email, the image processing apparatus 101 judges whether the new email is a reply email to a notification email transmitted by the image processing apparatus 101 (step S405), and if not a reply email (if No at step S405), the image processing apparatus 101 again checks for a new email.

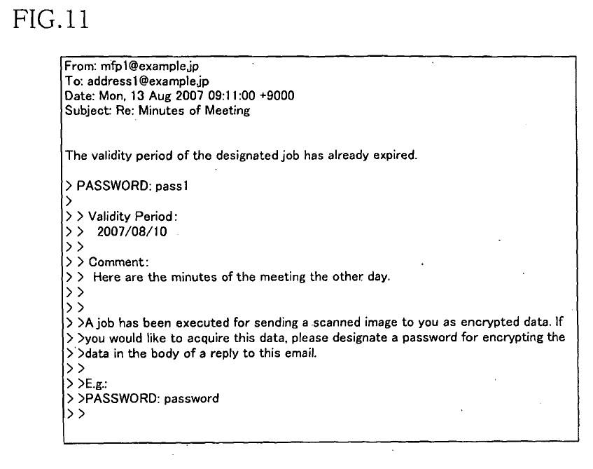

On the other hand, if the new email is a reply email (if Yes at step S405), the image processing apparatus 101 judges whether a corresponding job currently exists in the job management table (step S406), and if a corresponding job does not exist (if No at step S406), the image processing apparatus 101 transmits an email (see FIG. 11) to the sender (address) of the reply email notifying that the validity period has expired (step S407).

On the other hand, if a corresponding job exists in the job management table (if Yes at step S406), the image processing apparatus 101 judges whether the sender (address) of the received reply email is included in the addresses of that job (step S408), and if not included in the addresses (if No at step S408), the image processing apparatus 101 judges whether the reply email is in reply to an email notified to the sender (image sender) (step S409). If not in reply to a notification email to the sender (image sender) (if No at step S409), the image processing apparatus 101 judges whether there are any addresses to which the data of that job is unsent besides those that have instructed cancellation in the addresses of the job (step S412), and if there are no addresses to which data of that job is unsent (if No at step S412), the image processing apparatus 101 next judges whether holding of the job for the duration of the validity period is set (step S413), and if not set (if No at step S413), the job is deleted from the job management table (step S414), and then the image processing apparatus 101 judges whether to end the email reception process (step S415), and ends the reception process if judged in the affirmative.

Description of Address Response Process

If it is judged in step S408 that the sender (address) of the received reply email is included in the addresses of that job (if Yes), the image processing apparatus 101 implements the address response process of step S410.

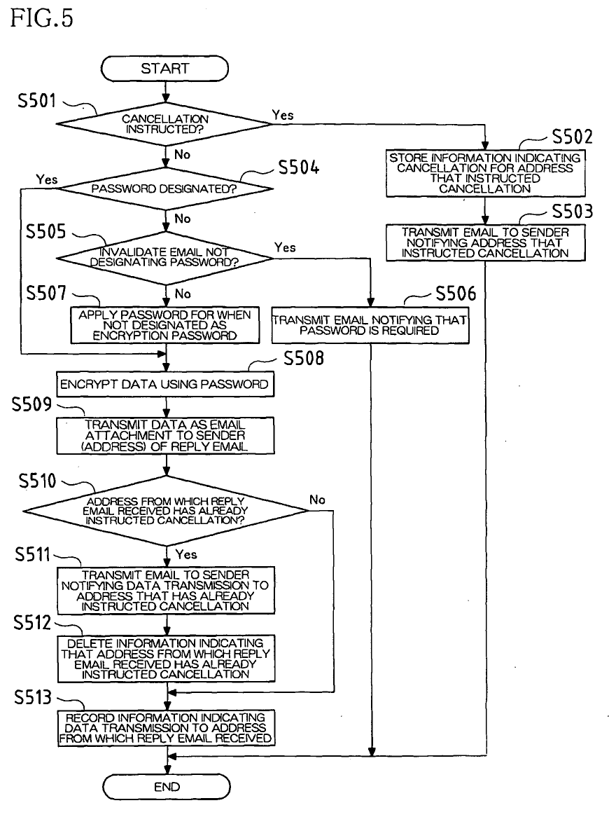

FIG. 5 is a flowchart showing the address response process implemented at step S410. Hereinafter, the address response process will be described with reference to this flowchart.

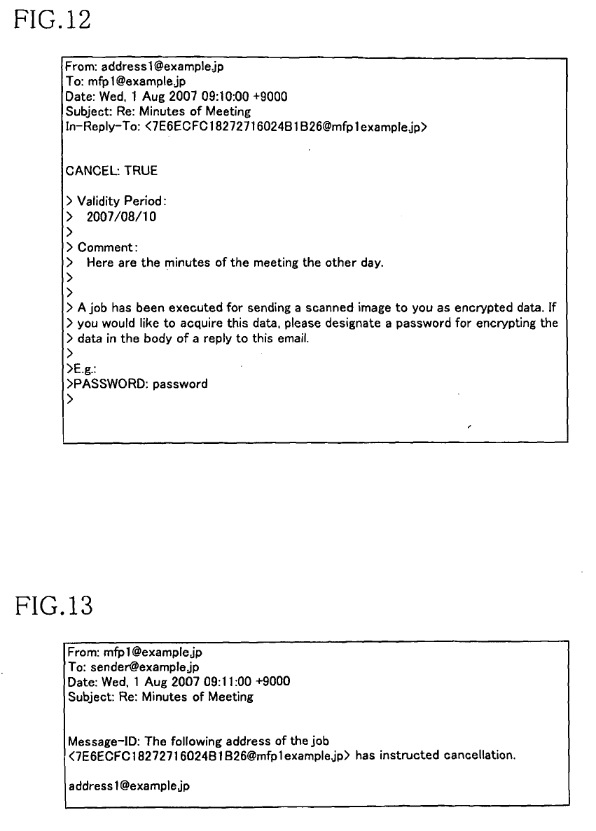

In the address response process, the image processing apparatus 101 judges whether cancellation of data reception is instructed by the received reply email (step S501), and if cancellation is instructed (see FIG. 12), the image processing apparatus 101 records information (CANCEL: TRUE) showing that a cancellation instruction has been received in corresponding address information managed in the job management table (step S502), and transmits an email (see FIG. 13) to the sender (image sender) notifying the address that has instructed cancellation (step S503).

On the other hand, if the sender (address) of the received reply email is included in the addresses of that job, and cancellation of data reception is not instructed (if No at step S501), the image processing apparatus 101 next judges whether a password for use in encryption is instructed in the received reply email (step S504). If a password for use in encryption is instructed in the reply email (see FIG. 15), the processing proceeds from step S504 to step S508, and the image processing apparatus 101 encrypts the data using the designated password, and transmits the encrypted data to the address of the sender of the reply email as an email attachment (step S509). In FIG. 15, “pass1” is designated as a password for use in encryption.

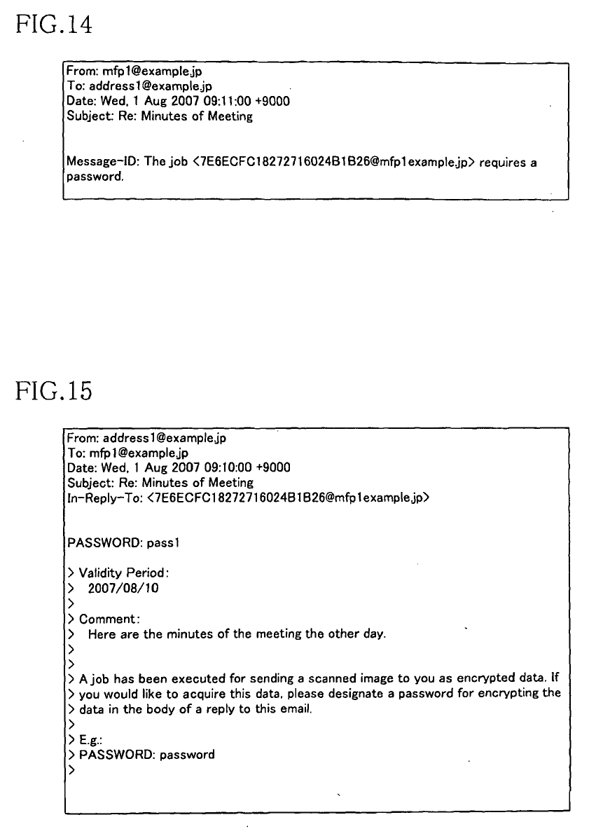

On the other hand, if a password is not designated (if No at step S504), the image processing apparatus 101 next judges whether a setting invalidating a reply email that does not designate a password has been made (step S505). If a setting invalidating a reply email that does not designate a password has been made (if Yes at step S505), an email (see FIG. 14) is transmitted to the address of the sender of the reply email (step S506) notifying that a password is required.

On the other hand, if a password is not designated, and a setting invalidating a reply email that does not designate a password has not been made (if No at step S504, and No at step S505), the image processing apparatus 101 applies a password set in advance for when a password has not been designated as a password for use in encryption (step S507), encrypts the data using this password (step S508), and transmits the encrypted data to the address of the sender of the reply email as an email attachment (step S509).

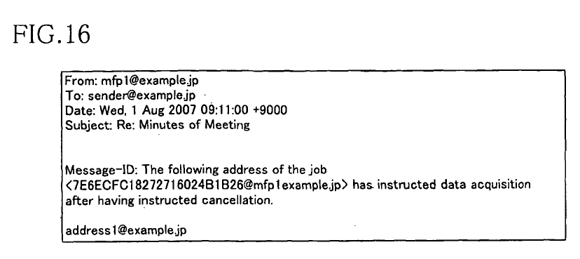

The image processing apparatus 101 then judges whether the address from which the reply email was received has already (in the past) instructed cancellation (step S510), and if cancellation was instructed in the past, the image processing apparatus 101 transmits an email (see FIG. 16) to the sender (image sender) notifying that the data acquisition instruction was received from an address that had already instructed cancellation (step S511), deletes record of the cancellation instruction from the corresponding address information in the job management table (step S512), and records the fact that data has been transmitted to the address from which the reply email was received (step S513).

Description of Sender Response Process

If, in step S409 of FIG. 4, the received reply email is in reply to a notification email transmitted to the sender (image sender), the image processing apparatus 101 implements the sender response process of step S411.

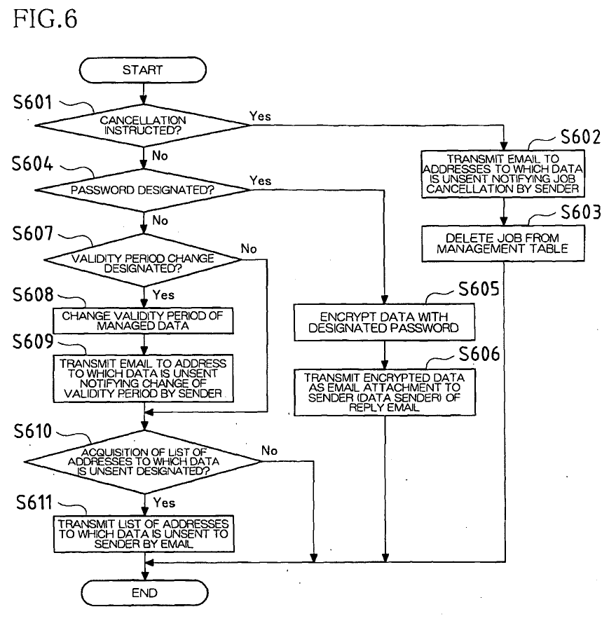

FIG. 6 is a flowchart showing the sender response process implemented at step S411. Hereinafter, the sender response process will be described with reference to this flowchart.

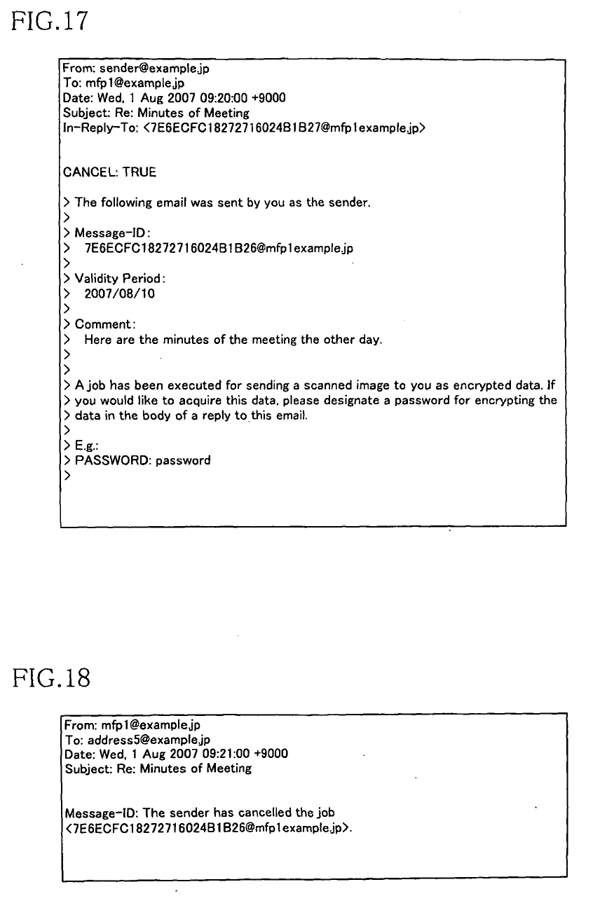

In the sender response process, the image processing apparatus 101 judges whether cancellation of the job is instructed by the received reply email (step S601), and if cancellation (CANCEL: TRUE) is instructed (see FIG. 17), the image processing apparatus 101 transmits an email (see FIG. 18) to any addresses to which data is unsent besides those addresses that have already instructed cancellation of data transmission notifying that the sender (image sender) has cancelled the job (step S602), and the job management unit 204 deletes the job to which the cancellation instruction relates from the job management table (step S603).

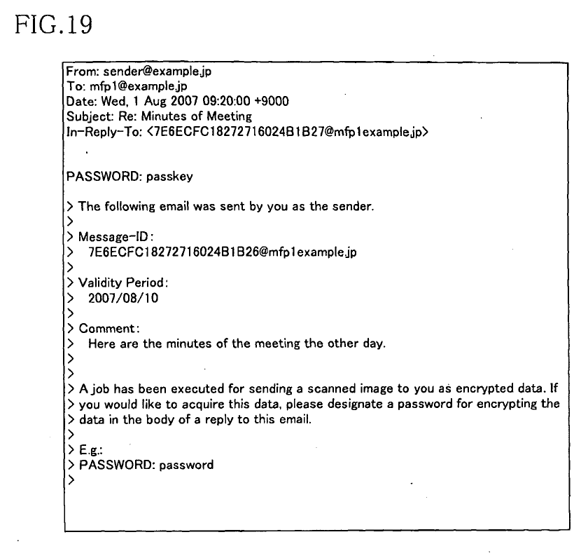

On the other hand, if the received reply email is not a job cancellation instruction (if No at step S601), the image processing apparatus 101 next judges whether a password for use in encryption is instructed (step S604). If a password is designated (see FIG. 19), the image processing apparatus 101 encrypts the data with the instructed password (“passkey” is designated as the password in the FIG. 19 example) (step S605), and transmits the encrypted data to the sender (data sender) as an email attachment (step S606).

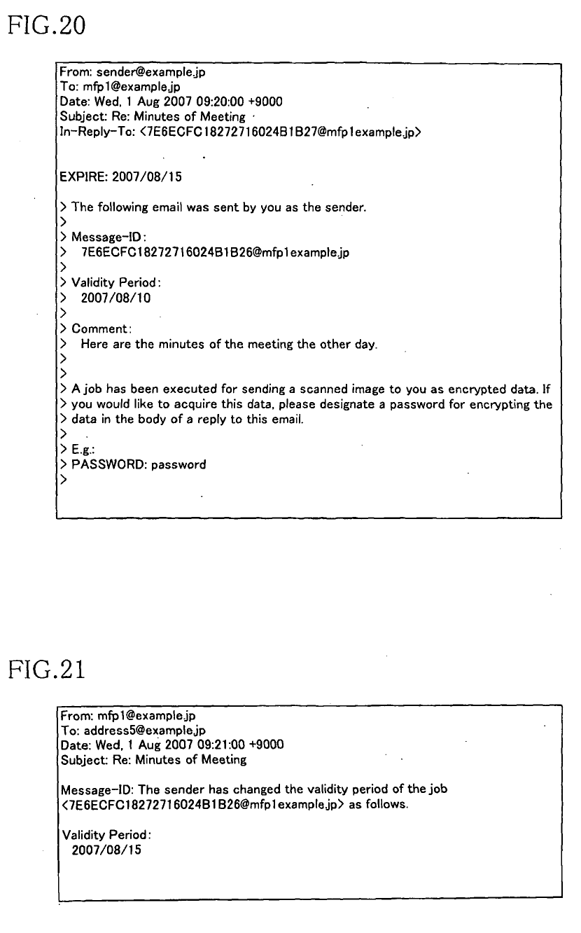

On the other hand, if neither a job cancellation instruction nor a password instruction (if No at step S601, and No at step S604), the image processing apparatus 101 next judges whether a validity period change is instructed (step S607). If a change instruction (see FIG. 20), the image processing apparatus 101 updates the job information with the instructed validity period (step S608), and transmits an email (see FIG. 21) to any addresses to which data is unsent besides those addresses that have already instructed cancellation, notifying that the sender (data sender) has changed the validity period (step S609). In FIG. 20, the validity period change instruction is written in a specific format (reserved name, separators, values). Specifically, the validity period change instruction is written in the form “EXPIRE: 2007/08/15”. That is, examples are shown in FIGS. 20 5 and 21 in which the validity period is changed from the original “2007/08/10” to “2007/08/15”.

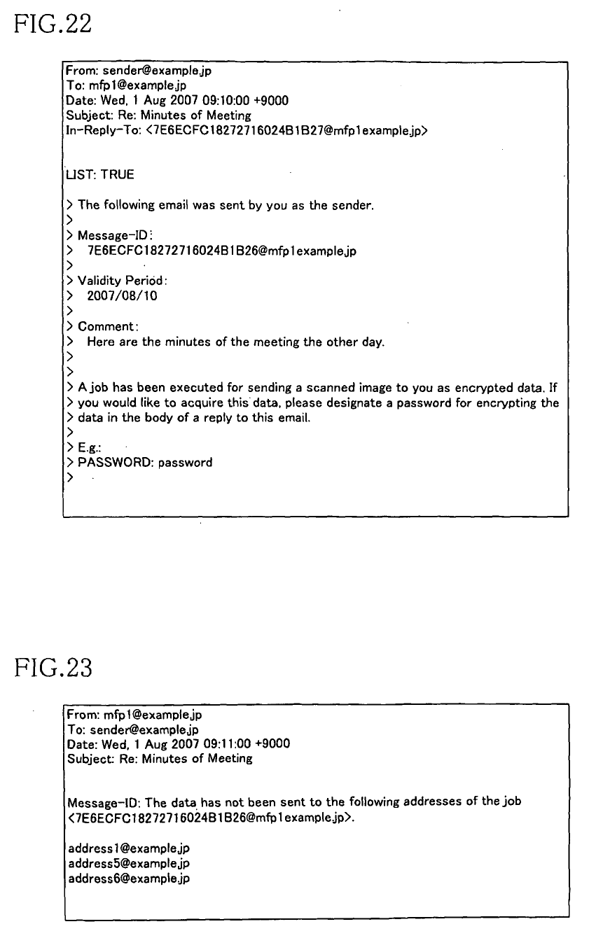

Further, if neither a cancellation instruction, a password instruction, nor a validity period change instruction, the image processing apparatus 101 next judges whether the reply email is an instruction for acquiring a list of addresses to which data is unsent besides those that have instructed cancellation (step S610). If an instruction for acquiring a list of addresses to which data is unsent besides those that have instructed cancellation (see FIG. 22), the image processing apparatus 101 transmits an email (see FIG. 23) to the sender (data sender) listing any addresses to which data is unsent at that point besides those that have instructed cancellation (step S611). In FIG. 22, list acquisition is instructed in the form “LIST: TRUE”, and in FIG. 23, the addresses of three users “address1”, “address5” and “address6” are listed as addresses to which data is unsent.

In the above description of the sender response process, a configuration was described where the validity period is changed as a result of an instruction from the sender, although the validity period may be changed automatically.

That is, the image processing apparatus 101 may monitor the validity period managed with the job management table, and when the validity period elapses, the image processing apparatus 101 may extend the current validity period by a preset fixed period (e.g., 5 days), if the number of addresses to which data has still not been transmitted at this point is greater than or equal to a preset fixed number. At this time, the image processing apparatus 101 may transmit an email to the client apparatuses of the addresses to which data has still not been transmitted at this point, notifying that the validity period has been automatically changed (extended). Here, greater than or equal to a fixed number may, for example, be greater than or equal to 50% of the original number of addresses scheduled to receive data transmission. That is, in the case where there were originally ten addresses scheduled to receive data transmission, the validity period would be automatically extended by five days if there remained five or more addresses to which data is unsent when the validity period elapsed. Note that such automatic extension may be performed a plurality of time, rather than only once. The sender may be allowed to set the number of times automatic extension can be performed. Thus, automatically extending the validity period enables the validity period to be automatically changed (extended) even if the sender forgets to change the validity period.

The present invention may be embodied in other forms without departing from the gist or essential characteristics thereof. The foregoing embodiments are therefore to be considered in all respects as illustrative and not limiting. The scope of the invention is indicated by the appended claims rather than by the foregoing description, and all modifications and changes that come within the meaning and range of equivalency of the claims are intended to be embraced therein.

What is claimed is:

1. An image processing apparatus that is connected to a mail server via a network and has an email function of transmitting to the mail server an email addressed to an address designated as a destination and receiving from the mail server an email addressed to the image processing apparatus, and an image transmission function of encrypting data read from an original set on an original table and transmitting to the mail server the encrypted data as email attachment data, comprising:
a notification email transmission means for transmitting to the mail server a notification email inquiring to a client apparatus of an address whether the encrypted data is to be received;
a reply email reception means for receiving a reply email from the mail server in response to the notification email, wherein the reply email is sent from the client apparatus of the address and indicates to receive the encrypted data; and
a data transmission means for encrypting the data using a password assigned to the received reply email, attaching the encrypted data to an email to be sent to the address as attachment data, and transmitting the email to the mail server.

2. The image processing apparatus according to claim 1, wherein when a plurality of addresses are designated as destinations, the data transmission means individually attaches encrypted data to emails to be sent to these addresses and transmits the emails thereto, with each the data being encrypted using a password designated in a reply email received from a client apparatus of each of the addresses.

3. The image processing apparatus according to claim 2, further comprising:
a validity period setting means for setting a validity period for which to continue to hold the data even after data transmission to all addresses is complete; and
a job management means for managing, as a job, the data, a sender, one or more addresses, a validity period condition and information on a notification email, wherein
the job management means associates a received reply email with a job currently being managed.

4. The image processing apparatus according to claim 3, wherein, if a job associated with a reply email received from a client apparatus of an address does not exist, the image processing apparatus transmits an email notifying the client apparatus of the address that the validity period has expired and the job has been deleted.

5. The image processing apparatus according to claim 3, further comprising a means for setting whether to, after the validity period has expired, automatically transmit data or cancel data transmission, with respect to an address to which the held data has not been transmitted.

6. The image processing apparatus according to claim 5, wherein if cancellation of data transmission after the validity period has expired is set with respect to an address to which the held data has not been transmitted, the image processing apparatus notifies a client apparatus of the address by email when the validity period expires that data transmission has been canceled due to the validity period having expired.

7. The image processing apparatus according to claim 5, wherein if cancellation of data transmission after the validity period has expired is set with respect to an address to which the held data has not been transmitted, the image processing apparatus notifies, to a client apparatus of the sender when the validity period has expired, a list of addresses with respect to which data transmission has been cancelled.

8. The image processing apparatus according to claim 3, wherein if a reply email indicating not to receive the encrypted data is received from a client apparatus of an address during the set validity period, the image processing apparatus cancels data transmission to the address.

9. The image processing apparatus according to claim 8, wherein the image processing apparatus notifies, by email to a client apparatus of the sender, information indicating the address to which data transmission was canceled.

10. The image processing apparatus according to claim 2, wherein the image processing apparatus, when executing the image transmission function, sets a character string for use as a password in a case where a character string serving as a password is not designated by a client apparatus of an address.

11. The image processing apparatus according to claim 10, wherein in a case where a character string serving as a password is not designated in a reply email received from a client apparatus of an address, the image processing apparatus sets whether to invalidate the reply email and inhibit data transmission to the address or encrypt the data using the password set for use when a password is not designated, attach the encrypted data to an email to be sent to the address, and transmit the email.

12. The image processing apparatus according to claim 11, wherein in a case where a character string serving as a password is not designated in a reply email received from a client apparatus of an address, and invalidating the reply email and inhibiting data transmission to the address has been set, the image processing apparatus transmits to the client apparatus of the address an email notifying that the reply email is invalid.

13. The image processing apparatus according to claim 3, wherein if invalid description is included in a reply email received from a client apparatus of an address, the image processing apparatus recognizes only valid description included in the reply email as an instruction.

14. The image processing apparatus according to claim 3, wherein the image processing apparatus, when executing the image transmission function, transmits to the client apparatus of the sender an email, wherein a content of the email is to inquire whether the encrypted data is to be received and additionally includes a statement that the email was sent by a receiver of the email himself.

15. The image processing apparatus according to claim 14, wherein when a reply email to the email transmitted to the client apparatus of the sender is received, the job management means saves, in association with the job currently being managed, information indicating that the received reply email was in reply to an email transmitted to the sender.

16. A data encryption communication system, wherein an image processing apparatus as claimed in any one of claims 1, 2, 3 and 10, a mail server, a client apparatus of an address that receives an email transmitted from the image processing apparatus and transmits a reply email to the received email, and a client apparatus of a sender are connected to one another via a network.
